(19) United States
(12) Patent Application Publication
(10) Pub. No.: US 2008/0178707 A1
(43) Pub. Date: Jul. 31, 2008

(54) Pliers for cutting and holding straps and the like

(76) Inventor: Mark Anthony Stevens, Lexington, OH (US)

Correspondence Address: Mark Stevens, 184 Industrial Drive, Lexington, OH, 44904, US

(21) Appl. No.: 12/004,812

(22) Filed: Dec. 21, 2007

Related U.S. Application Data
(60) Provisional application No. 60/897,338, filed on Jan. 25, 2007.

(51) Int. Cl. H02G 1/12; B25B 7/22

(52) U.S. Cl. 81/9.43; 7/132

(57) ABSTRACT

A hand tool similar in design to the commonly known “linesman” pliers with the added capacity to control the cut material during and after the cutting operation. The addition and placement of a shear edge on the outside of the jaw assembly allows the invention to maintain control of the cut material and to further manipulate the material if needed. The invention also include a tine on the leading edge of the above mentioned shear edge to increase the capacity of the invention to gain initial control of the material to be processed.

This application claims the priority of U.S. Provisional Patent No. 60/897,338 filed on Jan. 25, 2007.

### BACKGROUND OF THE INVENTION

1. Technical Field

The invention relates generally to pliers and handheld wire cutters. More particularly, the invention relates to pliers which incorporate a wire-cutting or strap-cutting capability. Specifically, the invention relates to such pliers which are configured both to simultaneously cut and hold a strap, a wire or the like.

2. Background Information

Pliers and handheld wire cutters are well known in the art. Pliers which have gripping jaws for holding various items in combination with cutting edges for cutting wires, straps and the like are also well known. Linesmans pliers, for example, all fall within this category. While such pliers are useful for both grasping and cutting straps and the like, they are not configured to simultaneously cut and hold a strap or wire. Nor do they employ a means or configuration that enhances their ability to effectively engage tightly affixed straps and the like.

However, there are various situations which this ability to simultaneously grasp and cut a strap or wire is desired. For instance, in more recent years, packaging of toys and the like has utilized wires or various straps which extend through holes in cardboard or other parts of a package and wrap around a portion of the toy or other packaged item in order to secure the toy or item to the package in an effort to reduce theft and ensure the security of the merchandise during shipping.

In such packaging, the wires or straps are configured in loops which must be cut or have the ends untwisted for removal. While some handheld wire cutters may be used to cut the strap or wire, these standard wire cutters do not allow the strap or wire to be held and controlled simultaneously. However, it is often necessary to pull the cut wire or strap through the holes in the package or from around the item of merchandise in order to release the item of merchandise from the package. In addition, sometimes such straps or wires may be cut more than one time which increases the likelihood of pieces thereof being strewn about the floor or various work surfaces. This not only creates a messy floor or work surface, but also may be a safety issue in creating small objects which may be swallowed by young children. The present invention addresses these and other problems in the art.

In Kaiser et al U.S. Pat. No. 6,006,633, there is proposed a pliers configuration that can serve both the purposes of grasping materials and cutting materials but the actions cannot be conveniently performed simultaneously on the same piece of material.

Further, in Elkins U.S. Pat. No. 7,174,640, the item is designed to cut cable ties leaving the end in a particular disposition. This tool does not gain control of the material to be cut at any point in the operation.

Further still, U.S. Pat. No. 5,235,750 Brown, there is a proposed pliers like shear that is designed to maintain control of the material that is being cut during and after the shearing operation. This tool is designed to handle large thickness workpieces and controls both sides of the material. The design does not lend itself to wire like materials and controlling both sides of the cut material disallows the option of pulling only one side of the material with the intent of removing it from whatever it is binding.

Another example of a cutting and holding tool is seen in Collins U.S. Pat. No. 7,073,261. This article is designed for pruning and loping operations and although it does maintain control of one side of the severed material its configuration does not lend itself to processing wire and cable tie like materials.

### BRIEF SUMMARY OF THE INVENTION

The present invention provides an apparatus comprising: first and second handles pivotally mounted on one another; first and second jaws respectively on the first and second handles and movable between open and closed positions; a first gripping surface on the first jaw; a second gripping surface on the second jaw which abuts or is closely adjacent the first gripping surface in the closed position; a side surface on the first jaw extending from the first gripping surface away from the second gripping surface; and a cutting projection on the second jaw which extends outwardly from adjacent the second gripping surface and which in the closed position extends beyond the first gripping surface in a direction away from the second gripping surface and is disposed closely adjacent or in abutment with the side surface.

### BRIEF DESCRIPTION OF THE SEVERAL VIEWS OF THE DRAWINGS

FIG. 1 is a side elevational view of the pliers of the present invention.

FIG. 2 is an enlarged fragmentary side elevational view of a portion of the pliers including the jaws.

FIG. 3 is an enlarged perspective view of the jaws of the pliers.

FIG. 4 is an end elevational view from the jaws end of the pliers.

FIG. 5 is a perspective view showing a wire or strap holding an object such as an item of merchandise to a wall such as the wall of a package.

FIG. 6 is a perspective view showing the tine on the leading edge of the jaws being inserted into a portion of the loop formed by the wire or strap prior to the cutting thereof.

FIG. 7 is a perspective view showing the jaws of the pliers having cut the wire and continuing to hold the wire.

FIG. 8 is similar to FIG. 7 and shows the jaws of the pliers still grasping the wire and having removed it from the wall to which it was attached.

Similar numbers refer to similar parts throughout the drawings.

### DETAILED DESCRIPTION OF THE INVENTION

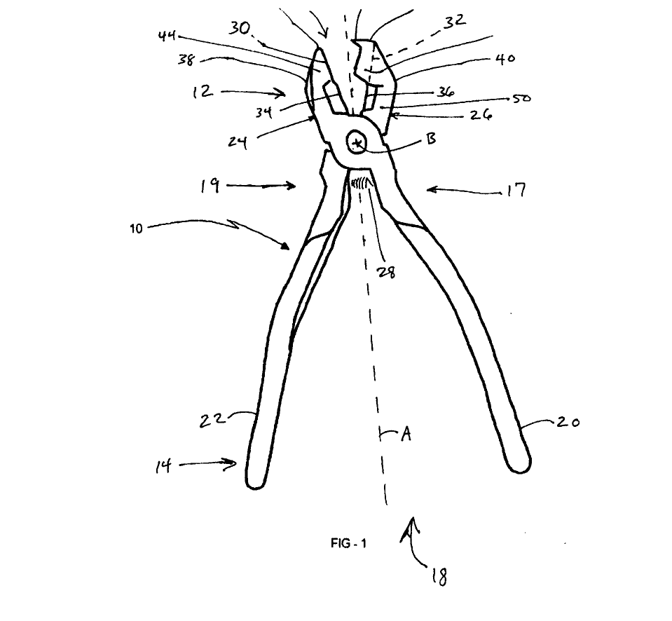

The pliers of the present invention are shown generally at 10 in FIG. 1. Pliers 10 are configured to cut and hold straps, wires and the like, and are especially useful for cutting and holding straps which are looped around an object or objects secured thereby. Pliers 10 include a jaw assembly 12 and a handle assembly 14 respectively adjacent first and second ends 16 and 18 which define therebetween a longitudinal direction of pliers 10. FIG. 1 shows longitudinally extending reference plane A passing through the pivot about which jaw assembly 12 and handle assembly 14 pivot.

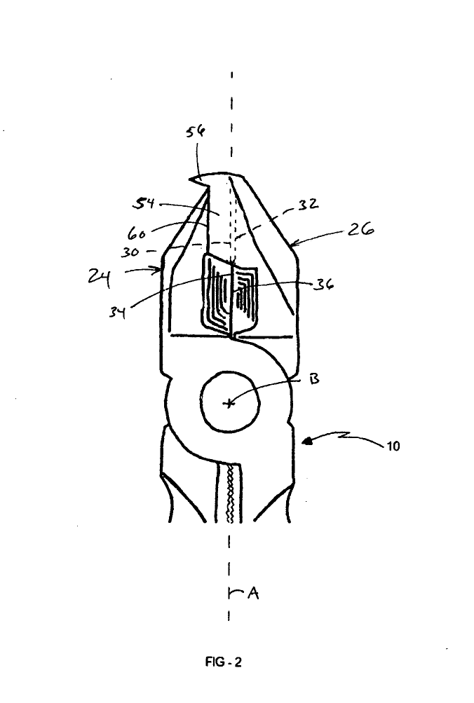

To facilitate an understanding of the invention, pliers 10 are indicated as having a top 17 and a bottom 19. Handle assembly 14 includes a first or top handle 20 and a second or bottom handle 22 each of which is longitudinally elongated. Jaw assembly 12 includes a first or bottom jaw 24 connected to top handle 20 and a second or top jaw 26 connected to bottom handle 22. Typically, top handle 20 and bottom jaw 24 are a rigid integral one-piece member. Likewise, bottom handle 22 and jaw 26 are typically a rigid integral one-piece member. Thus, the handles and jaws pivot about an axis B which lies in plane A between an open position (FIG. 1) and a closed position (FIG. 2). Pliers 10 may include a spring 28 between handles 20 and 22 so that pliers 10 are spring biased to the open position. As is the case with standard linesmen pliers, the pivoting of the handles and jaws occur only about a single axis, unlike adjustable pliers having a pivot which is moveable within a slot to increase or decrease the distance between the jaws for gripping objects with a wider variety of sizes. The single-axis concept for pliers 10 provides greater precision by eliminating the play between the handles experienced with the adjustable type pliers.

Bottom and top jaws 24 and 26 include respective bottom and top gripping surfaces 30 and 32 which face one another, are spaced from one another in the open position and are closely adjacent or abut one another in the closed position. FIG. 2 shows surfaces 30 and 32 being spaced slightly from one another in the closed position. Surfaces 30 and 32 are substantially flat and substantially parallel to or lie along plane A in the closed position. Each of surfaces 30 and 32 is typically knurled to provide greater gripping ability. Each of gripping surfaces 30 and 32 extends radially outwardly with respect to axis B. Jaws 24 and 26 respectively include bottom and top cutting edges 34 and 36 positioned radially inwardly from gripping surfaces 30 and 32 with respect to axis B. Each of cutting surfaces 34 and 36 likewise extend radially outwardly from axis B, are spaced apart from one another in the open position and abut one another in the closed position so that they lie along plane A in the closed position whereby they are configured to cut wires and straps in a standard manner.

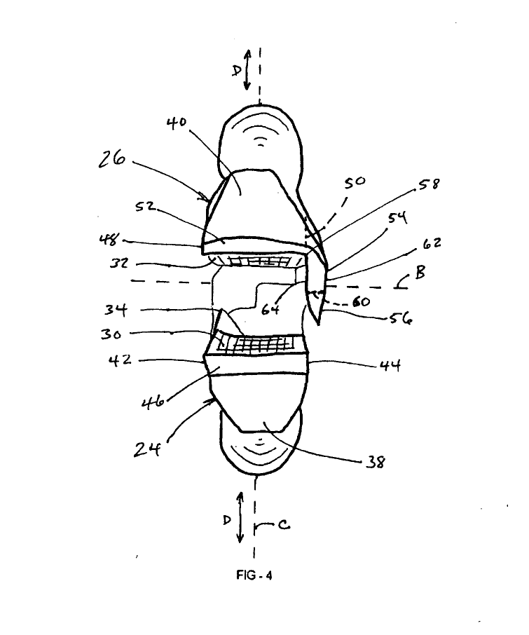

Bottom jaw 24 has a downwardly facing bottom surface 38. Top jaw 26 has an upwardly facing top surface 40. Referring to FIG. 4, surfaces 38 and 40 face generally away from one another and away from gripping surfaces 30 and 32. Bottom jaw 24 has first and second opposed sides 42 and 44 which are substantially parallel to one another and a plane C which cuts through pliers 10 as shown in FIG. 4 and along which handles 20 and 22 and jaws 24 and 26 are moveable (arrow D) between the open and closed positions. Plane C is thus substantially perpendicular to axis B and plane A. Bottom jaw 24 also includes a third outer surface or side 46 at first end 16 which typically is substantially perpendicular to each of planes A and C and parallel to axis B. Third side 46 faces away from axis B and handles 20 and 22. Each of sides 42, 44 and 46 intersect and extend downwardly from gripping surface 30 toward bottom 38 of jaw 24, and thus extend generally away from top gripping surface 32 and jaw 26.

With continued reference to FIG. 4, top jaw 26 includes first and second opposed outer surfaces or sides 48 and 50 which are substantially parallel to plane C and respectively aligned with sides 42 and 44 of bottom jaw 24. Top jaw 26 further includes a third outer surface or side 52 which is substantially perpendicular to each of planes A and C and parallel with axis B. Third side 52 is aligned with third side 46 of bottom jaw 24. Each of sides 48 and 52 intersect and extend upwardly from top gripping surface 32 toward top 40 of jaw 26 and thus away from bottom gripping surface 30 and bottom jaw 24. Side 50 extends upwardly from a position radially inward of gripping surface 32.

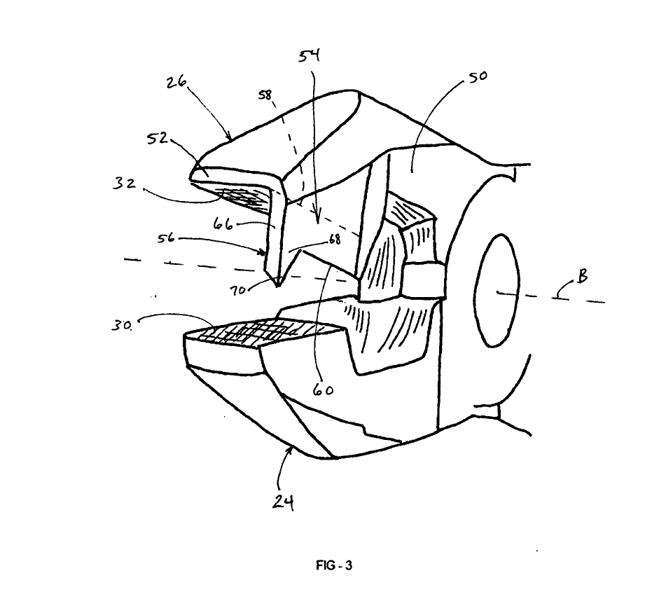

In accordance with the invention, top jaw 26 includes a cutting projection 54 and a tine 56 which extend downwardly from gripping surface 32 and generally toward bottom jaw 24 when in the open position. More particularly, cutting projection 54 extends outwardly from second side 50 of upper jaw 26 away from first side 48 and downwardly from gripping surface 32 along a plane in which second side 50 lies. Cutting projection 54 thus intersects gripping surface 32 at an radially extending linear intersection 58 (FIGS. 3-4) along a boundary of surface 32 which is furthest from side 48 and aligned with side 50. Cutting projection 54 terminates at a longitudinally extending cutting edge 60. Cutting projection 54 has an outwardly facing surface 62 which faces away from first side 48 and an inwardly facing surface 64 which faces toward first side 48. Surface 64 is substantially perpendicular to gripping surface 32 and is closely adjacent or in abutment with second side 44 of lower jaw 24 in the closed position with cutting edge 60 disposed below gripping surface 30 in an overlapping fashion.

Tine 56 extends downwardly from cutting edge 60 and thus further away from top gripping surface 32. Tine 56 extends downwardly from adjacent third side 52 of top jaw 26 and may together with cutting projection 54 form an outer surface 66 which intersects third side 52 and faces away from axis B and handles 20 and 22. Tine 56 typically tapers downwardly in a narrowing fashion from a wider portion 68 (FIG. 3) adjacent cutting edge 60 to a narrower terminal portion 70 so as to form a generally pointed lower end of tine 56.

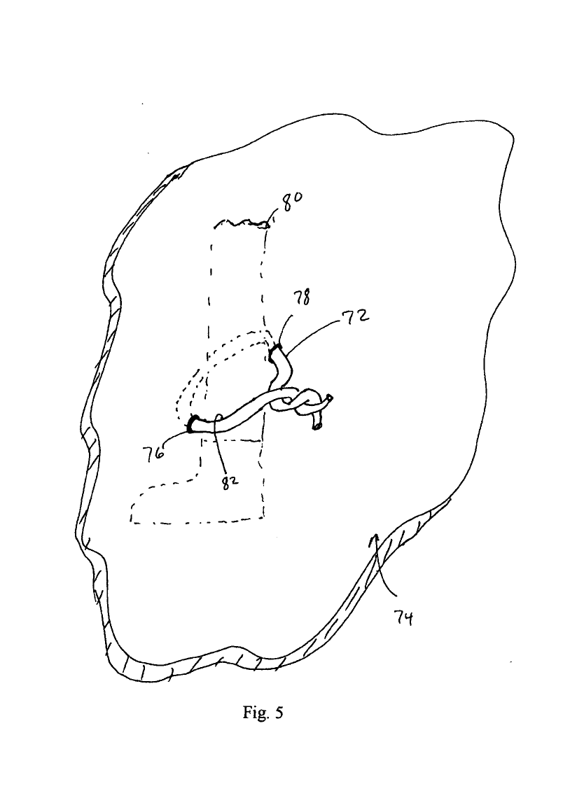

The operation of pliers 10 is described with reference to FIGS. 5-8. FIG. 5 shows generally a wire or strap 72 which is used to secure two or more items to one another. For purposes of illustration, one of the objects is referred to as a wall 74 having a pair of holes 76 and 78 formed therethrough. Wall 74 may be any structure with a pair of holes extending therethrough and may be, for example, a wall of a package used to attach another object such as an item 80 of merchandise. Item 80 here is shown in fragmentary and dashed lines as the leg of a toy doll although item 80 may be any object. As shown in FIG. 5, strap or wire 72 extends through each of holes 76 and 78 and loops around item 80 and is twisted adjacent its free ends in order to secure item 80 to wall 74. Other straps which are commonly used are plastic straps having one-way ratchet teeth thereon which allow for the tightening of the loop formed thereby around an item such as item 80 while preventing removal of one end of the strap from the other. It will be appreciated that various types of straps or wires may be used for this purpose. The loop of strap or wire 72 forms an interior space 82 there within in which a portion of wall 74 is disposed with strap 72 tightened to a degree so that only a relatively small portion of space 82 extends outwardly from wall 74.

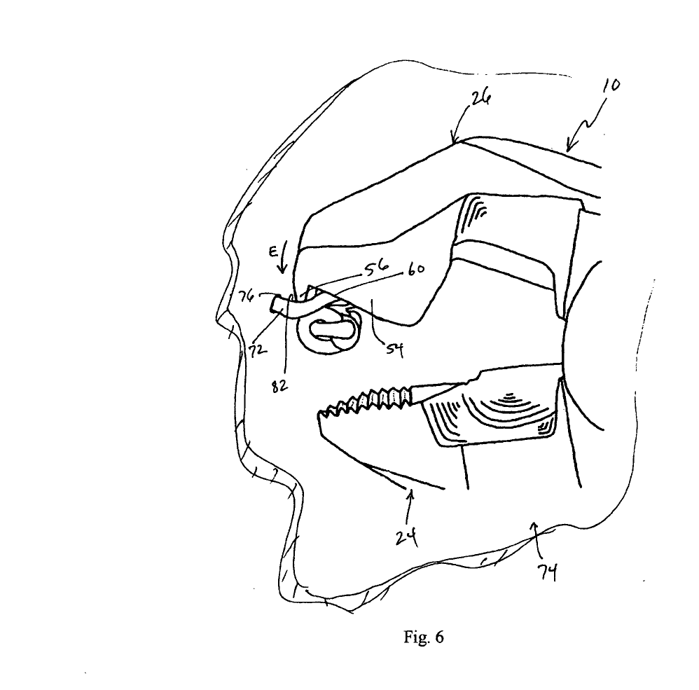

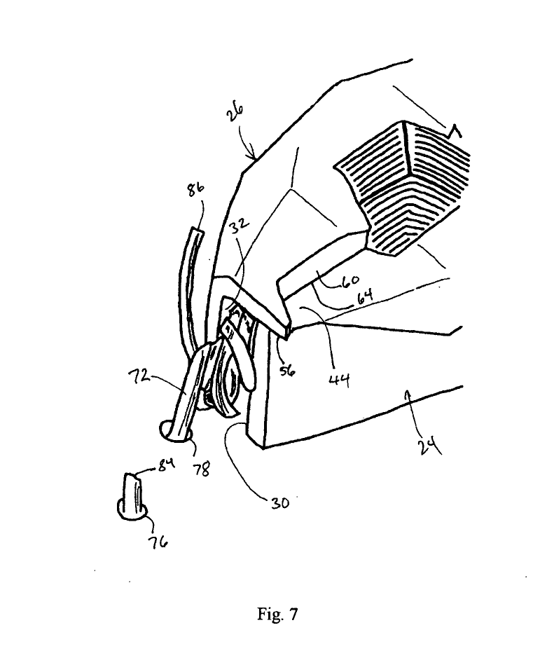

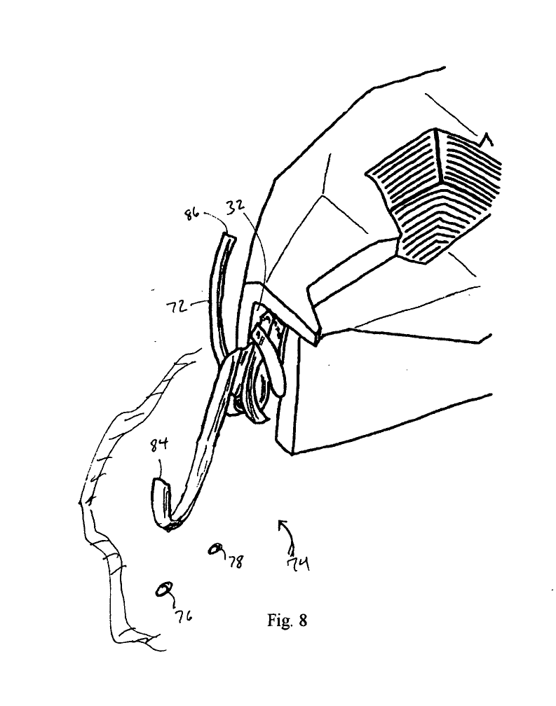

Referring to FIG. 6, jaws 24 and 26 are positioned adjacent strap 72 and tine 56 is inserted into space 82 (arrow E) between strap 72 and wall 74 so that a portion of strap 72 is positioned adjacent cutting edge 60 of cutting projection 54. As shown in FIG. 7, jaws 24 and 26 move toward the closed position in response to the squeezing together of handles 20 and 22 so that cutting projection 54 and bottom gripping surface 30 along second side 44 of lower jaw 24 cut wire 72 as cutting edge 60 moves downwardly beyond gripping surface 30 and inwardly-facing surface 64 of cutting projection 60 slides closely adjacent or in abutment with second side 44 in a shearing action. Wire 72 is thus severed to produce two cut ends 84 and 86. As the cutting action occurs, gripping surfaces 30 and 32 grip the twisted portion of wire 72 and are thus configured to remove strap 72 from wall 74 while maintaining control of it. More particularly, as shown in FIG. 8, pliers 10 apply a force away from wall 74 to pull the portion of strap 72 adjacent cut end 84 through holes 76 and 78 and from around item 80 so that strap 72 is free from wall 74 and item 80, and item 80 is no longer attached to wall 74.

Pliers 10 are thus configured to conveniently provide a gripping and a cutting capability which may be applied simultaneously in order that the gripping surfaces of the jaws of the pliers are able to maintain a grasp on the wire or strap, which is cut in a single cutting and clamping action via a single closing of pliers 10. Thus, even if a given wire or strap might be cut by standard cutting edges of, for instance, linesman pliers, it would require the additional opening and closing of such pliers in order to further grasp the wire which would be cut thereby. Pliers 10 further offers the advantage of being able to easily cut a wire or strap which forms a closed loop or is otherwise disposed closely adjacent the object to which it attached via the insertion of the tine adjacent its cutting edge. Various changes may be made to pliers 10 which are within the scope of the present invention. One option is a cutting projection similar to cutting projection 54 which extends downwardly from top jaw 26 and overhangs third side 46 of bottom jaw 24 so that the cutting action would take place along third side 46 with a cutting projection disposed closely adjacent thereto in the closed position of such a pair of pliers.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus comprising:
first and second handles pivotally mounted on one another;
first and second jaws respectively on the first and second handles and movable between open and closed positions;
a first gripping surface on the first jaw;
a second gripping surface on the second jaw which abuts or is closely adjacent the first gripping surface in the closed position;
a side surface on the first jaw extending from the first gripping surface away from the second gripping surface; and
a cutting projection on the second jaw which extends outwardly from adjacent the second gripping surface and which in the closed position extends beyond the first gripping surface in a direction away from the second gripping surface and is disposed closely adjacent or in abutment with the side surface.

2. The apparatus of claim 1 further comprising a tine on the cutting projection which projects outwardly therefrom away from the second gripping surface.
